(19) United States
(12) Patent Application Publication
(10) Pub. No.: US 2022/0118289 A1
(43) Pub. Date: Apr. 21, 2022

(54) MEDICAL DEVICE FOR THE INTERDICTION OF AIRBORNE BACTERIA AND VIRUSES

(71) Applicant: William Craig Willan, (US)

(72) Inventor: William Craig Willan, Custer, SD (US)

(73) Assignee: William Craig Willan, Custer, SD (US)

(21) Appl. No.: 17/121,485

(22) Filed: Dec. 14, 2020

Related U.S. Application Data
(60) Provisional application No. 63/094,736, filed on Oct. 21, 2020.

(51) Int. Cl. A62B 18/00; A62B 18/08

(52) U.S. Cl. CPC A62B 18/003; A62B 18/08; A62B 18/006

(57) ABSTRACT

Devices, systems, and methods for generating an air curtain and/or air wall around a user's face to prevent airborne viruses and bacteria from coming within close proximity of the user's facial features. The devices include a wearable head-mount with an air manifold and a pack including an air pump and a filter. The filter can be replaceable. Filtered air is forced through tubing to the air manifold. The air manifold provides a filtered air curtain around the user's face. The methods include utilizing the device to generate an air curtain around a user's face.

### PRIORITY

This application is a non-provisional application of and claims priority to and the benefit of U.S. Prov. App. No. 63/094,736, filed Oct. 21, 2020, the entire disclosure of which is incorporated herein by reference in its entirety.

### BACKGROUND

### Field

Embodiments of the disclosure relate to providing a personal air curtain or air wall with a medical device to protect bodily facial features. In particular, embodiments of the disclosure relate to devices, systems, and methods that provide an optionally filtered air curtain or air wall to eliminate or reduce movement or passage of airborne viruses and bacteria toward and/or away from a human face.

### Description of the Related Art

Protecting an individual from pathogens, pollutants, or other particulates has generally been accomplished by facial coverings, such as masks covering the nose and mouth, glasses or goggles covering the eyes, or full hoods or masks that cover the entire face. Some hoods encompass the entire head. These protection devices protect an individual by physically blocking environmental particulates from reaching the nose, mouth, eyes, or skin. Some devices can allow air to flow through the device to allow for breathing, such as a mask, which filters out pathogens or particulates. Some devices prevent all air from being around the face, nose, or mouth by a physical barrier, such as a hood, while breathing air is provided from a filter or a pressurized air or oxygen source away from the face.

These devices can provide some protection, but masks are not always effective at blocking particles or pathogens from entering the respiratory system. Additionally, masks and hoods can affect speech and communication, and can block the facial expressions of users—an important tool for communicating, especially with children and the hard of hearing community. Masks make reading lips nearly impossible. Some individuals suffering from claustrophobia, mental illness, or psychological distress cannot wear a mask or struggle to wear a mask or a hood due to anxiety. Other individuals, such as children or those with developmental delays or mental handicaps, cannot wear a mask or hood due to the inability to understand the need to wear a mask, or the inability to pull the mask away in a situation of distress. Individuals with health conditions such as severe COPD or difficulty breathing may have a difficult time wearing a mask.

Therefore, other effective methods and devices for preventing airborne pathogens from nearing an individual's face are needed.

### SUMMARY

The present disclosure presents devices, systems, and methods for generating a protective facial air curtain of a clean flowable fluid around a user's facial features. The protective facial air curtain can block aerosol particles, pathogens, microorganisms, and other particulates from nearing an individual's facial features. The device includes a flowable fluid manifold which can be affixed to a frontal brim of a head-mount. The flowable fluid manifold includes fluid distribution ports from which a fluid can flow. When fluid is provided to the flowable fluid manifold, the flowable fluid generates the protective facial curtain of the user. The flowable fluid can come from a flowable fluid supply, such as a blower or compressed air supply. The blower can be in a filtration pack, and include a filter. The flowable fluid can be supplied to the flowable fluid manifold via one or more supply tube.

The present disclosure also presents a method of blocking particles and pathogens including viruses and bacteria from nearing an individual's face by generating the protective air curtain directed downward and angled forward away from a perpendicular plane in front of the user's face, creating an air pocket in front of the individual's face. The protective air curtain is created by generating a differential pressure which can move air from the environment surrounding the individual through a filter, filtering air through the filter, and forcing the filtered air through the fluid distribution ports in the flowable fluid distribution manifold. The protective air curtain surrounds the individual's facial features for protection.

In some embodiments, an air pocket between a user's face and the air curtain (or air wall), the air curtain being provided from a brim of a head-mount to proximate a user's neck, increases in depth sequentially from a user's forehead, to the user's eyes, to the user's nostrils, then to the user's mouth, providing sequentially increasing protection via increasing depth of the air pocket from the user's eyes to the user's mouth. The forward angle of the air curtain, advantageously provided by the air manifold, surprisingly and unexpectedly provides greater depth of an air pocket proximate the user's nostrils and mouth than the depth of the air pocket at the eyes, where risk of infection from airborne pathogens at the user's nose and mouth can be greater than at the eyes. Such a forward angle of an air curtain in some embodiments can be between about 5 degrees and about 45 degrees forward from a perpendicular plane extending downwardly from the brim of the head mount, in some embodiments can be between about 10 degrees and about 30 degrees forward from a perpendicular plane extending downwardly from the brim of the head mount, and in some embodiments can be about 20 degrees forward from a perpendicular plane extending downwardly from the brim of a head mount. In embodiments described here, a user need not feel the air curtain on facial features, and a static, protective air pocket of increasing depth between the user's forehead and mouth exists between the air curtain and a user's face.

Therefore, disclosed here is a device for providing a protective air curtain around a user's facial features. The device includes a head-mount with a frontal brim, wearable by the user; a light, wearable filtration pack including a flowable fluid supply, which in some embodiments can produce filtered air; a flowable fluid manifold which can be affixed to the frontal brim, which includes a flowable fluid distribution port which generates the protective air curtain angled downward and forward away from a 90 degree perpendicular to the frontal brim when the flowable fluid is provided to the flowable fluid manifold; and a supply tube including a first end and a second end, where the first end is fluidly connected to the flowable fluid manifold and the second end is fluidly connected to the flowable fluid supply so that the flowable fluid is supplied from the flowable fluid supply to the flowable fluid manifold.

In some embodiments, the head-mount wearable by the user is selected from the group consisting of a hat, a visor, a helmet, glasses, an umbrella, a cap, and any combination of the same. In some embodiments, the light, wearable filtration pack comprises an air intake, an air pump, and a filter. The air pump can produce the filtered air by drawing ambient air through the air intake and the filter. In some embodiments, the light, wearable filtration pack also includes a battery to operate at least one of the air intake or the air pump. In further embodiments, the battery comprises a rechargeable lithium ion battery. In some embodiments, the filter comprises a removable and replaceable N-95 filter. In other embodiments, the light, wearable filtration pack includes a supplemental oxygen or compressed air supply.

In some embodiments, the protective air curtain does not intersect the user's facial features, such as any one of or any combination of the user's forehead, eyes, nose, mouth, and chin, such that the user does not feel the fluid on the user's facial features. In some embodiments, the flowable fluid distribution port includes a plurality of perforations to generate the protective air curtain downwardly away from the flowable fluid manifold, and outward such that the protective air curtain is angled forward away from the user's facial features generating an air pocket in front of the user's facial features. Still in some embodiments, the flowable fluid distribution port is positioned such that the protective air curtain surrounds the user's face, extending cross-wise from proximate a first temple, proceeding in front of the user's face, to proximate a second temple, and vertically downward from the frontal brim in front of the user's face to proximate a user's neck or proximate a user's chin and jaw line.

In some embodiments, the protective air curtain is positioned such that the air pocket is increasing in depth sequentially from the user's forehead, to a user's eyes, to a user's nostrils, to a user's mouth, and operated to provide sequentially increasing protection to the user's eyes, the user's nostrils, and the user's mouth. In other embodiments, the protective air curtain is angled forwardly away from the plane extending perpendicular to the frontal brim at an angle between about 5 degrees and about 45 degrees. In still other embodiments, the protective air curtain is positioned between about 1 inch and about 5 inches from a user's forehead, for example about 4 inches, so that the air pocket between the user's eyes and the protective air curtain is between about 1 inch and about 5 inches deep, for example about 4 inches, the air pocket between the user's nostrils and the protective air curtain is between about 1 inch and about 6 inches deep, for example about 5 inches, and the air pocket between the user's mouth and the protective air curtain is between about 1 inch and about 7 inches deep, for example about 6 inches.

Also disclosed is a system for adding a protective air curtain to a head-mount, the system including a light, wearable filtration pack including a flowable fluid supply; a supply tube fluidly connected to the flowable fluid supply, capable of transporting fluid; and a flowable fluid manifold including a flowable fluid distribution port. The flowable fluid manifold is fluidly connected to the supply tube, and can generate a pressurized screen of the fluid when the fluid is provided to the flowable fluid manifold through the supply tube. The pressurized screen of the fluid is generated downward at an angle forward and away from a plane perpendicular to a frontal brim.

In some embodiments, the system includes an attachment device which can removably affix the flowable fluid manifold to a head-mount wearable by a user. In some embodiments, the filtration pack also includes an air compressor, an air intake, and an air outlet. The air compressor can produce a differential pressure to move air from the air intake to the air outlet, where the air outlet is fluidly connected to the supply tube.

In further embodiments, the system also includes a filter enclosing the air intake. The filter can remove pollutants, pathogens, particulates, and microorganisms to generate filtered air. In other embodiments, the system includes a compressed air supply or supplemental oxygen supply.

In some embodiments, the pressurized screen of the fluid is angled forwardly away from the plane extending perpendicular to the frontal brim of the head mount at an angle between about 5 degrees and about 45 degrees. In further embodiments, a protective air pocket is generated by the pressurized screen of the fluid when the head mount is positioned on a user's forehead, the protective air pocket of increasing depth between a user's forehead and a user's mouth. In still further embodiments, the flowable fluid manifold is positioned between about 1 inch and about 5 inches from a user's forehead, so that the protective air pocket between the user's eyes and the pressurized screen of the fluid is between about 1 inch and about 5 inches deep, the protective air pocket between the user's nostrils and the pressurized screen of the fluid is between about 1 inch and about 6 inches deep, and the protective air pocket between the user's mouth and the pressurized screen of the fluid is between about 1 inch and about 7 inches deep. In some embodiments, the user does not feel the pressurized screen of the fluid on the user's facial features due to the forward angle of the pressurized screen and the static nature of the air pocket.

Also disclosed is a method of blocking aerosol particles and pathogens from nearing an individual's face. The method includes the steps of generating a differential pressure, the differential pressure capable of moving air from an environment surrounding the individual through a filter. The method also includes filtering the air through the filter, where the filter is able to remove pollutants, pathogens, and microorganisms to generate filtered air; forcing the filtered air through a fluid distribution port in a flowable fluid manifold to generate a protective air curtain; and directing the protective air curtain to surround the individual's facial features, so that the protective air curtain prevents pathogens from passing through the protective air curtain and nearing the individual's facial features.

In some embodiments, the protective air curtain is generated downwardly and forwardly away from a plane extending perpendicular to a frontal brim of a head mount. In some embodiments, the protective air curtain is angled forwardly away from a plane extending perpendicular to the frontal brim at an angle between about 5 degrees and about 45 degrees. In further embodiments, the protective air curtain is positioned between about 1 inch and about 5 inches from a user's forehead, so that the protective air pocket between the user's eyes and the protective air curtain is between about 1 inch and about 5 inches deep, the protective air pocket between the user's nostrils and the protective air curtain is between about 1 inch and about 6 inches deep, and the protective air pocket between the user's mouth and the protective air curtain is between about 1 inch and about 7 inches deep. For example, the air pocket could be about 3 to about 5 inches deep at a user's forehead and eyes, about 4 inches to about 6 inches deep at the nostrils, and about 5 inches to about 7 inches deep at the mouth, between the user's facial features and the air curtain.

In some embodiments, the method also includes the step of pushing the filtered air through a supply tube fluidly connecting the flowable fluid manifold and the filter so that the filtered air is transported from the filter to the flowable fluid manifold. In some embodiments, the step of directing the protective air curtain generates an air pocket in front of the individual's facial features, so that the individual does not feel the protective air curtain on the individual's facial features. In some embodiments, the air pocket is sufficiently deep to prevent an inhalation or exhalation of the individual from interrupting the protective air curtain, thus interdicting entry and/or exit of pathogens such as viruses and bacteria.

In some embodiments, a brim of a head-mount, for example the brim of a baseball cap or visor, can extend between about 1 inch and about 5 inches or between about 3 inches and about 4 inches, or about 3 inches forwardly in front of a user's forehead. Providing an air manifold for an air curtain at or near the forward end of the brim, then, provides an initial air pocket between the air curtain and the user's forehead between about 2 inches and about 5 inches or between about 3 inches and about 4 inches, or about 3 inches forwardly in front of a user's forehead. As noted, a forward angle of an air curtain in some embodiments can be between about 5 degrees and about 45 degrees forward from a perpendicular plane extending downwardly from the brim of a head mount, in some embodiments can be between about 10 degrees and about 30 degrees forward from a perpendicular plane extending downwardly from the brim of the head mount, and in some embodiments can be about 20 degrees forward from a perpendicular plane extending downwardly from the brim of a head mount. In embodiments described here, a user need not feel the air curtain on facial features, and a static, protective air pocket of increasing depth between a user's forehead and mouth exists between the air curtain and a user's face.

With the forward angle of the air curtain, the air pocket between the user's eyes and the air curtain is greater than the air pocket depth between the user's forehead and the air curtain. This provides protection again pathogens such as viruses and bacteria at the eye membrane. Providing an air manifold for an air curtain at the forward end of the brim, then, provides an air pocket between the air curtain and the user's eyes between about 1 inch and about 5 inches or between about 3 inches and about 4 inches, or about 3.5 inches forwardly in front of a user's eyes, creating an air pocket of greater depth between the eyes and air curtain than between the forehead and air curtain.

With the forward angle of the air curtain, the air pocket between the user's nostrils and the air curtain is greater than the air pocket depth between the user's eyes and the air curtain. This provides protection against pathogens such as viruses and bacteria at the nasal and olfactory membranes. Providing an air manifold for an air curtain at the forward end of the brim, then, provides an air pocket between the air curtain and the user's nostrils between about 1 inch and about 6 inches or between about 3 inches and about 5 inches, or about 4 inches forwardly in front of a user's nostrils, creating an air pocket of greater depth between the nostrils and air curtain than between the eyes and air curtain. With some viruses and bacteria, such as COVID-19, the nasal and olfactory membranes are more susceptible to infection than the eyes, and thus surprisingly and unexpectedly the angled designs of the present air curtains provide increasing protection via increasing air pocket depth proximate important routes of infection.

With the forward angle of the air curtain, the air pocket between the user's mouth and the air curtain is greater than the air pocket depth between the user's nostrils and the air curtain. This provides protection against pathogens such as viruses and bacteria at the oral membranes. Providing an air manifold for an air curtain at the forward end of the brim, then, provides an air pocket between the air curtain and the user's mouth between about 1 inch and about 7 inches or between about 3 inches and about 6 inches, or about 4 or 5 inches forwardly in front of a user's mouth, creating an air pocket of greater depth between the mouth and air curtain than between the forehead/eyes/nostrils and air curtain. With some viruses and bacteria, such as COVID-19, the oral membranes are more susceptible to infection than the eyes, and thus surprisingly and unexpectedly the angled designs of the present air curtains provide increasing protection via increasing air pocket depth proximate important routes of infection.

### BRIEF DESCRIPTION OF THE DRAWINGS

These and other features, aspects, and advantages of the present disclosure will become better understood with regard to the following descriptions, claims, and accompanying drawings. It is to be noted, however, that the drawings illustrate only several embodiments of the disclosure and are therefore not to be considered limiting of the disclosure's scope as it can admit to other equally effective embodiments.

FIGS. 1A through 1E depict various views of a head-mount portion of the protective air curtain device, according to an embodiment shown with a cap.

FIG. 2 depicts a protective air curtain device system, according to an embodiment.

FIG. 3 depicts the fluid supply portion of the protective air curtain device, according to an embodiment.

FIGS. 4A and 4B depict optional fluid supply sources, according to some embodiments.

FIGS. 5A and 5B depict the protective air curtain device, according to other embodiments.

FIGS. 6A through 6E depict various angles of the head-mount portion of the protective air curtain device, according to some embodiments.

FIG. 7 depicts a side view of an embodiment of a protective air curtain device head-mount portion showing the forward angled protective air curtain and air pocket, according to some embodiments.

FIGS. 8A through 8C depict an air pump and air intake for use with a removable and changeable filter material, for example for use in a light, wearable filtration pack, according to some embodiments.

### DETAILED DESCRIPTION

So that the manner in which the features and advantages of the embodiments of devices, systems, and methods for generating a protective facial air curtain for a user, as well as others, which will become apparent, may be understood in more detail, a more particular description of the embodiments of the present disclosure briefly summarized previously may be had by reference to the embodiments thereof, which are illustrated in the appended drawings, which form a part of this specification. It is to be noted, however, that the drawings illustrate only various embodiments of the disclosure and are therefore not to be considered limiting of the present disclosure's scope, as it may include other effective embodiments as well.

Disclosed herein are medical devices, systems, and methods for generating a protective air curtain or screen around a user's facial features. An air curtain is a broad, moving, pressurized stream of air that prevents particulates, contaminates, aerosols, pathogens such as viruses, bacteria, and other microorganisms, and ambient air from crossing through the air curtain. A protective air curtain can include one or more air stream, in addition to or alternative to other fluids such as oxygen, in a substantially vertical and forward-angled plane of flowing, clean air, in addition to or alternative to a substantially horizontal, plane of flowing, clean air, such as filtered air, that flows around the user's facial features, such as the user's eyes, nose, and mouth. The width, height, and depth of an air curtain are adjustable to prevent not only fluid droplets but also pathogens and microorganisms from crossing through the air curtain. The protective air curtain prevents contaminants, pollutants, aerosols, pathogens, microorganisms, viruses, dust, allergens, other particulates, excretions from others, such as cough or sneeze droplets, or any combination of the same, from crossing the air curtain and nearing the user's facial features. The protective air curtain can surround the user's face, extending cross-wise from behind or proximate a first temple, proceeding in front of the user's face, to behind or proximate a second temple, and vertically from a frontal brim of a head-mount to near or proximate a user's neck or chin and jawline, and in some embodiments extends outward beyond and below a user's chin, away from the user's face.

Advantages of the disclosed systems, devices, and methods include protecting the user from exposure to pathogens, viruses, aerosols, microorganisms, particulates, contaminants, pollutants, and other airborne or droplet-carried particles. The device protects not only the user's airways, including the nose and mouth, but also the user's eyes, which can be an important and often overlooked pathway for infection-causing microorganisms to enter the body via exposed membranes. Advantageously, in some embodiments, the device cleans the air before generating the fluid flow by using one or more filters. The filter can include highly effective fabric filtering media, such as an N-95 mask, so that the air flow is sanitary, for example one or more N-95 mask, in series or parallel, removing 95% or more airborne particulate matter and pathogens. The elements of the device can be primarily situated in a filtration pack or in the head-mount away from the user's face and out of the way of the user allowing the facial features of the individual to be physically uncovered behind the transparent protective air curtain, clearly visible to those around him or her.

Advantageously, the air curtain does not blow or generate an air flow on the user's face, making the device suitable for individuals sensitive to facial contact. In some embodiments, to advantageously extend battery life of devices described here, the medical device air flow rate is set only to block small airborne pathogens such as viruses and bacteria, and is not set high enough sufficient to block larger particulate matter such as airborne pollutant or dust particles.

Visibility of facial features via transparency of a protective air curtain, in some embodiments, is especially beneficial for individuals who interact with children or those who are hard of hearing, where facial expressions and reading lips can be important communication elements. Additionally, due to the flowing air, the lack of elements touching the lower facial features of the individual (especially the mouth and nose), and open design, symptoms and anxiety relating to claustrophobia, mental illness, or psychological distress, may be lessened versus other facial coverings. These advantages also extend to other individuals, such as children or those with developmental delays or mental handicaps, who cannot wear a mask or hood due to the inability to keep a mask or hood on, or the inability to pull the mask or hood away in a situation of distress. Embodiments can be integrated into and disguised in a cap that an individual already wears, making user protection convenient without worrying about vanity or obstruction. Individuals with health conditions such as severe COPD or difficulty breathing can also benefit from the device without sacrificing protection. Such devices and methods disclosed herein also benefit restaurants, providing protection from virus and bacteria exchange between patrons while eating and imbibing, versus masks, which cannot be worn while eating and imbibing.

In at least one embodiment, the device includes a head-mount, the head-mount including a frontal brim. The head-mount can include a baseball cap, visor, hat, helmet, pair of glasses, headband, umbrella, or any combination of the same. The device also includes a flowable fluid manifold. The flowable fluid manifold can be removably affixed to the frontal brim of the head-mount. In some embodiments, the flowable fluid manifold includes clips, pins, adhesive, in addition to or alternative to other attachment devices so that the flowable fluid manifold can be removably affixed to the frontal brim of the head-mount. In some embodiments, the flowable fluid manifold is fully incorporated into the frontal brim of the head-mount, such as being located inside (out of view), outside, or along the brim of a cap. The flowable fluid manifold can be made of metal, plastic, PVC, in addition to or alternative to other materials.

The flowable fluid manifold includes one or more flowable fluid distribution ports which, when fluid is provided to the flowable fluid manifold, generates one or more pressurized stream of fluid which creates the protective air curtain. The flowable fluid distribution port can include a thin slit proceeding along the manifold affixed to the brim of a head-mount, a plurality of small holes proceeding along the manifold affixed to the brim of a head-mount, a plurality of slots proceeding along the manifold affixed to the brim of a head-mount, a plurality of small perforations proceeding along the manifold affixed to the brim of a head-mount, a plurality of annular openings proceeding along the manifold affixed to the brim of a head-mount, or any other type of egress or combination thereof. Fluid flow is provided through one or more flowable fluid distribution port in the manifold of a head-mount.

Flowable fluid distribution ports are directed downward such that the protective air curtain generated is directed downward in front of a user's facial features and slightly forward, generating an air pocket between the user's face and air curtain, where the air curtain and/or air pocket can be substantially U-shaped in the cross section. The protective air curtain does not intersect or contact the user's facial features, and the user should not feel air blowing on the face when the device is worn properly in suitable environmental conditions. The air curtain does not provide the sole source or a major source of breathing air to the user, but surprisingly and unexpectedly still protects the user from airborne pathogens even without providing direct filtered breathing air to the user. The user's breathing air comes from the air pocket. The protective air curtain is angled such that the air pocket is deep enough near the user's nose and mouth so that when the user inhales and/or exhales, the protective air curtain or air wall is continuous and not affected, interrupted, or otherwise moved from its position. The continuous, robust air curtain or air wall provides an environmental divide between the air pocket and an environment external to the air pocket.

The protective air curtain extends from the head mount and flowable fluid manifold downward at an angle forward from and past the 90 degree perpendicular, such that an air pocket is generated between the user's face and the air curtain. The forward angle past the 90 degree perpendicular can be greater than about 5 degrees, alternatively greater than about 20 degrees, alternatively greater than about 30 degrees, and alternatively greater than about 40 degrees. The forward angle from the 90 degree perpendicular can be in the range of about 5 degrees to about 45 degrees, or in the range of about 20 degrees to about 30 degrees. In some embodiments, the protective air curtain is substantially parallel to the bridge of the user's nose. In some embodiments, flowable fluid distribution ports are designed such that the air flow exiting the ports is angled, such that the ports are slanted within the manifold. In some embodiments, the manifold is positioned on the forward brim so that the ports of the manifold are rotated forward away from the 90 degree perpendicular. The manifold and ports are adjustable by a user in some embodiments, for example moveable along the length of a brim of a head-mount and turnable.

In some embodiments, total fluid flow, for example air flow or filtered air flow, through an air pump or blower (in addition to through one or more optional filter) to a flowable fluid manifold and one or more fluid distribution port to form the facial air curtain is between about 10 liters per minute and about 125 liters per minute, or between about 20 liters per minute and about 80 liters per minute, or between about 30 liters per minute and about 50 liters per minute, or at about 20 liters per minute or about 40 liters per minute. Since the protective air curtain is designed to block airborne viruses and bacteria, as well as aerosols which can contain those microorganisms, the required air can have a lesser flow and lesser volume than what is necessary to block airborne particulates such as dust or pollutant particles.

Thus, surprisingly and unexpectedly, the devices disclosed herein provide greater protection from viruses and bacteria without an extreme airflow or extended battery load. Even aerosols, due to their high surface area to weight ratio, do not require as much air pressure or volume to divert away from a user's face as compared to solid particulates. The lesser air flow and lesser air throughput is advantageous as it requires less power, resulting in a longer battery life. In cases where compressed fluid provides the fluid flow to the flowable fluid manifold, such as when an air cylinder is used, the requirement for less air throughput results in an increased run-time before the compressed fluid must be replaced or refilled. The fluid flow has a higher pressure than the ambient air pressure, allowing the generated protective air curtain to push through ambient air. For example, in embodiments of the present disclosure, to prevent air curtain or air wall penetration by viruses, bacteria, and/or aerosols, only about 30% to 40% of a full air flow is required for a blower providing a maximum air flow of 125 liters per minute.

In some embodiments, fluid flow is provided by a blower or pump. In some embodiments, the blower device is a 2″ by 2″ blower. In some embodiments, the blower device is a 3″ by 3″ blower. The power supply of the blower can include a rechargeable lithium ion battery with a 3″ by 6″ by 1″ dimension. The blower and power supply can be designed to fit within a light, wearable filtration pack. The filtration pack can include a bag, a fanny pack, a backpack, a satchel, a purse, or any type of bag-like container. In some embodiments, the blower and power supply are attached to the head mount in a compact, head-mount-only air curtain device.

For example, in one embodiment one or more air pump can be disposed in a lightweight, wearable pack such as a You Cheng Industrial Co. of China VN-C4 air pump running at 42 watts and 40 liters per minute with one or more 12 volt batteries, such as a TalentCell Model # YB 1206000-USB 12v 6000 mAh battery with a life of about 500-1000 recharge cycles, typical for lithium ion batteries. Based in part on air pump power draw, battery power, and number of batteries the air flow rate is adjustable for a user to strengthen or weaken the facial air curtain based on air flow, and the charge of a given device can last between about 1 hour and about 20 hours, between about 5 hours and about 15 hours, or about 8 or about 10 hours.

In some embodiments, the blower has an inlet and an outlet, and the filter is placed over the inlet of the blower, so that the blower pulls ambient air through the filter to generate a filtered air flow from the outlet. The filter can include one or more N-95 mask, in series or parallel, or can be made out of an N-95 material. The filter is removable and changeable by a user. The filter can be replaced or cleaned. In some embodiments, a filter comprises a polyester-polyethylene blend of woven media, for example an N-95 mask of 3M Corporation of St. Paul, Minn.

In some embodiments, all or a portion of the fluid flow for the air curtain is provided by a compressed fluid supply. The compressed fluid supply can include a compressed air supply or a compressed oxygen supply, for example. Suitable devices known to those of ordinary skill in the art for generating oxygen from ambient air can be used in some embodiments to provide supplemental oxygen to a facial air curtain.

In some embodiments, the fluid flow is provided from the fluid supply by one or more supply tubes. The supply tube can be a flexible tube made of plastic, rubber, latex, light-weight metal, or any other flexible, bendable, or pre-shaped material. The supply tube can connect the flowable fluid manifold to the fluid supply. A portion of the supply tube with perforations can operate as the flowable fluid manifold affixable to a brim of a head-mount.

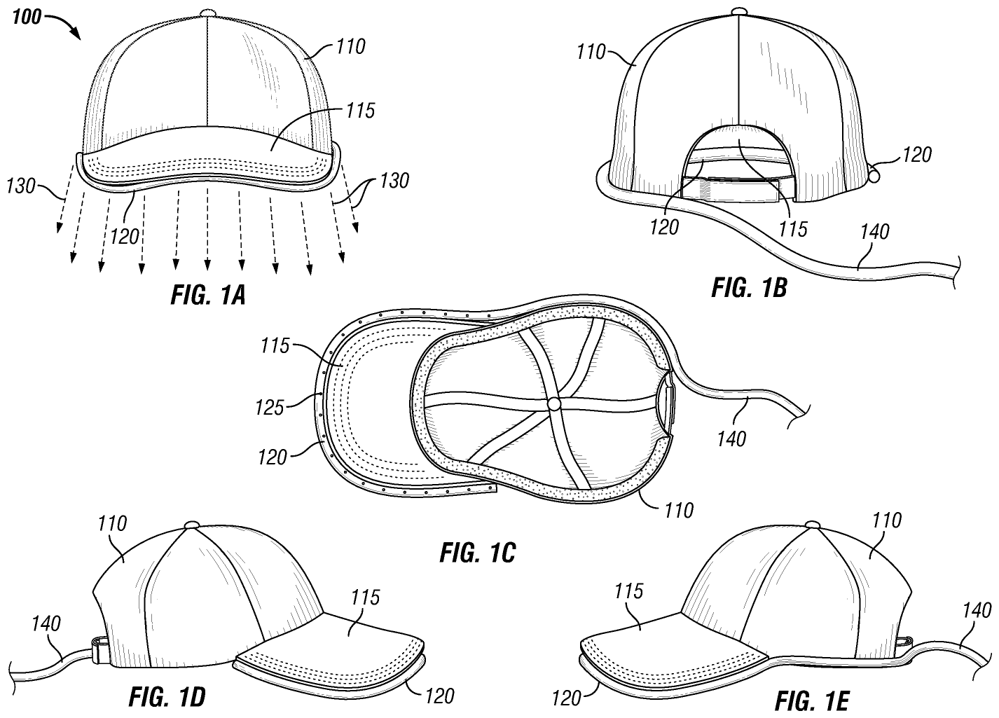

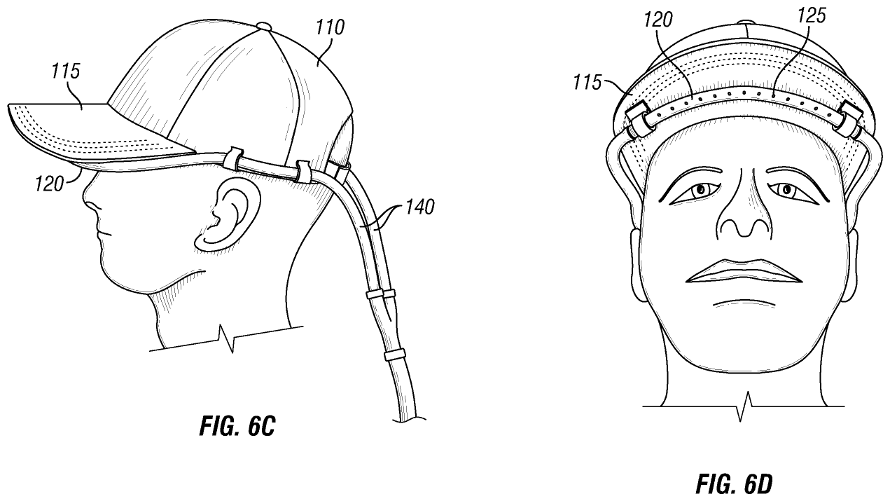

Referring to FIGS. 1A-1E, head-mount portion of the protective air curtain device 100 is shown. Head-mount 110, in the embodiment shown, is a cap with frontal brim 115. Flowable fluid manifold 120 is attached to the underside of frontal brim 115. As shown in FIG. 1A, flowable fluid manifold 120, when supplied with the fluid supply, generates an air curtain (shown by downward arrows) with direction of fluid flow 130 extending from flowable fluid manifold 120 downward in a substantially vertical plane, extending from proximate temple to temple of the user, and optionally slightly forward from frontal brim 115 away from the user's face. The air curtain therefore is substantially U-shaped in the cross section. Flowable fluid manifold 120 includes a plurality of flowable fluid distribution ports 125 (FIG. 1C), aligned and angled so that when fluid is supplied to flowable fluid manifold 120, a contiguous pressurized fluid sheet is generated in direction of fluid flow 130. Supply tube 140 is fluidly connected to flowable fluid manifold 120 so that fluid flows from the fluid supply (not shown) to flowable fluid manifold 120. Supply tube 140 is attached to the side of head-mount 110 and proceeds to a fluid supply via the rear of head-mount 110 as shown in FIGS. 1B, 1C, and 1E. Supply tube 140 can connect at one location to flowable fluid manifold 120 as shown in FIG. 1, or at multiple locations, described further with regard to FIGS. 6A-6B.

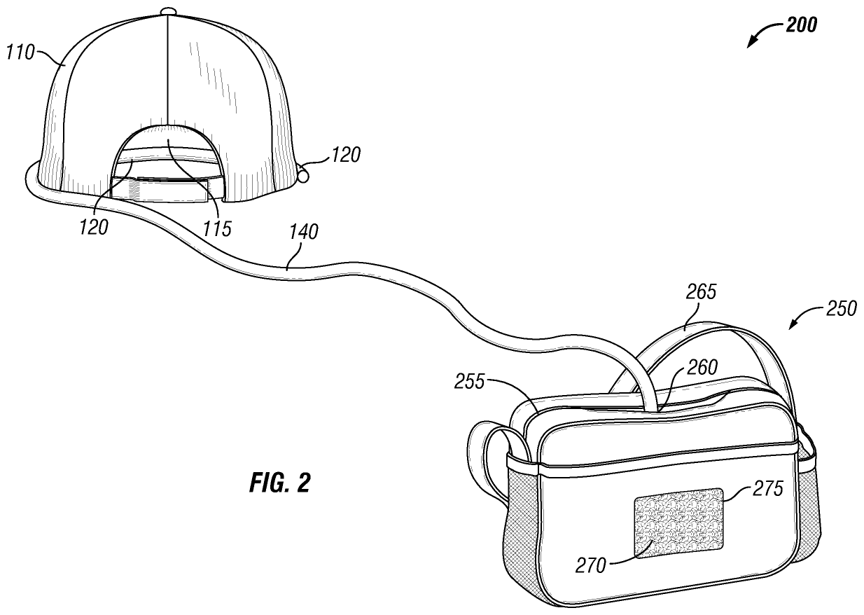

Referring now to FIG. 2, facial air curtain device 200 is shown. Filtration pack 250 is a light, wearable pouch, within which is contained the fluid supply (not shown). Filtration pack 250 includes pack access 255, which allows for access to the fluid supply (not shown). Pack access 255 can be a zipper, button closure, flap, or other access point that allows entry to the internal space of filtration pack 250. Filtration pack 250 also includes tubing access 260, from which supply tube 140 exits filtration pack 250. Filtration pack 250 includes an optional filtration pack attachment 265 which allows the individual to easily carry filtration pack 250 hands-free. Filtration pack attachment 265 is a waist strap. In some embodiments, filtration pack attachment 265 is a belt clip. In some embodiments, filtration pack 250 is a backpack and filtration pack attachment 265 are two backpack straps.

In other embodiments, a filtration pack 250 with air intake and air filtration are fully integrated into a head-mount, such as for example a baseball cap. In some embodiments of FIG. 2, head-mount 110 and supply tube 140 together weigh less than about a pound, less than about half a pound, or less than about an ounce. In some embodiments, filtration pack 250 including all components such as one or more battery, one or more air pump, and one or more filter weighs less than about 6 pounds, less than about 5 pounds, less than about 4 pounds, less than about 3 pounds, or less than about 2 pounds. In other words, additional weight born by a user's head can be about or less than 1 ounce, and a lightweight, wearable pack can be between about 1 pound and about 3 pounds.

Filtration pack 250 includes air intake 270. Air intake 270 allows for the fluid supply to access ambient air for compression and transport to the flowable fluid manifold 120. Air intake 270 includes filter 275. Filter 275 can include any type of filter and any combination of one or more filter. In some embodiments, filter 275 includes one or more N-95 mask that can be replaced or cleaned. Filter 275 covers the entirety of air intake 270, such that if air is pulled in through air intake 270 by the blower, it becomes filtered air in supply tube 140. Through supply tube 140, the fluid supply within filtration pack 250 is sent to the flowable fluid manifold (not shown) attached to head-mount 110. Filtering devices for ambient air can include UV light, other cloth filters such as cotton material, and liquid fluids.

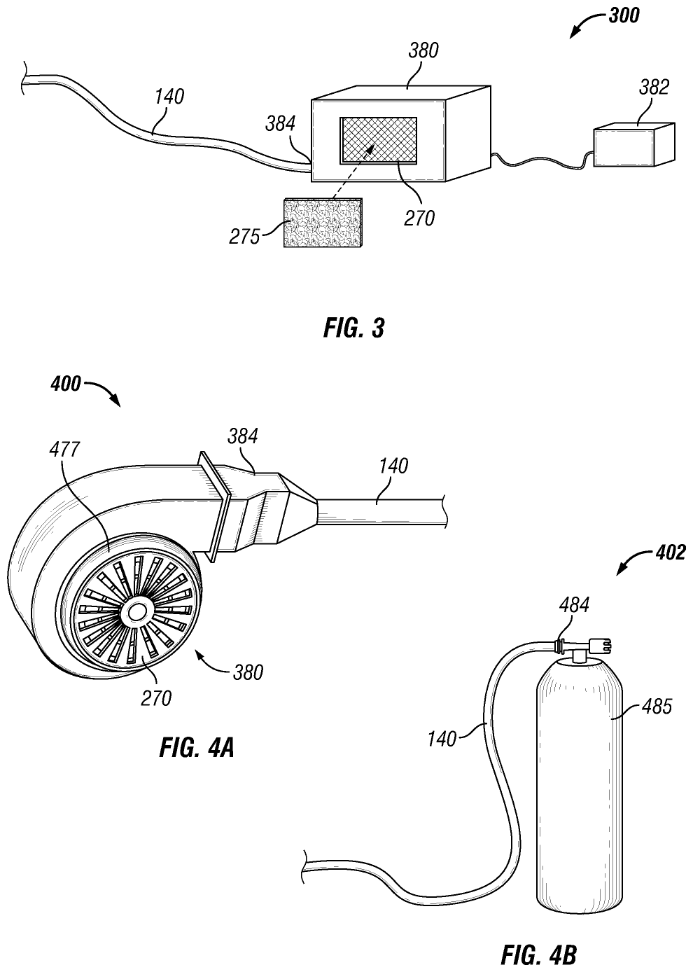

Referring now to FIG. 3, air supply portion of protective air curtain device 300 is depicted. Air pump 380 provides fluid supply to a flowable fluid manifold (not shown). Air pump 380 can include an air compressor, an air blower, or any other device or combination of devices capable of increasing the air velocity or pressure to pull air into air pump 380 and push air out of air pump 380 at air outlet 384. Air pump 380 includes air intake 270, which allows air to enter air pump 380. Filter 275 is placed over or within air intake 270 to filter the air drawn into air pump 380. Air outlet 384 allows filtered air to exit air pump 380. Supply tube 140 is fluidly connected to air outlet 384 so that the filtered air is directed to the flowable fluid manifold (not shown). Power supply 382 powers air pump 380. Power supply 382 can include a rechargeable lithium ion battery in addition to or alternative to other power sources.

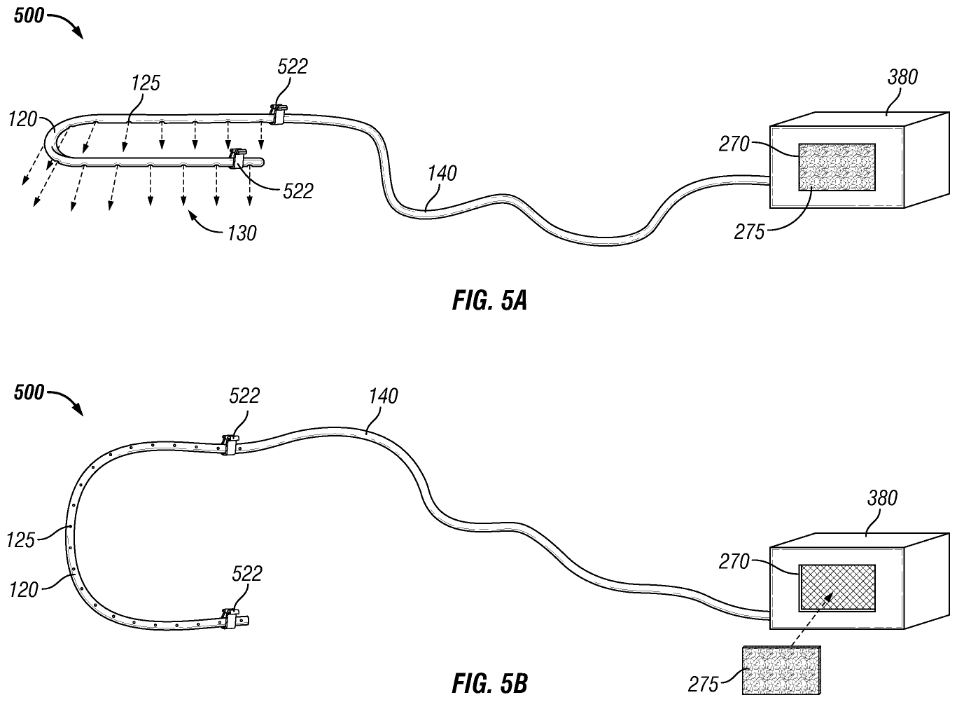

Referring now to FIGS. 4A and 4B, fluid supply 400 is shown. FIG. 4A depicts the inner-workings of air pump 380, in one embodiment, which includes air intake 270. Air pump 380 includes filter attachment mechanism 477, which includes a series of clips that allows a filter (not shown) to be removably attached to air intake 270. Air outlet 384 connects to supply tube 140 so that the filtered air flow generated by air pump 380 can be transported through supply tube 140 to the flowable fluid manifold (not shown).

FIG. 4B depicts a different embodiment of a fluid supply 402. Compressed air supply 485 is a compressed air cylinder containing air. Compressed air supply 485 can contain oxygen enriched air or oxygen. Compressed air outlet 484 connects to supply tube 140 so that the filtered air flow generated by compressed air supply 485 can be transported through supply tube 140 to the flowable fluid manifold (not shown).

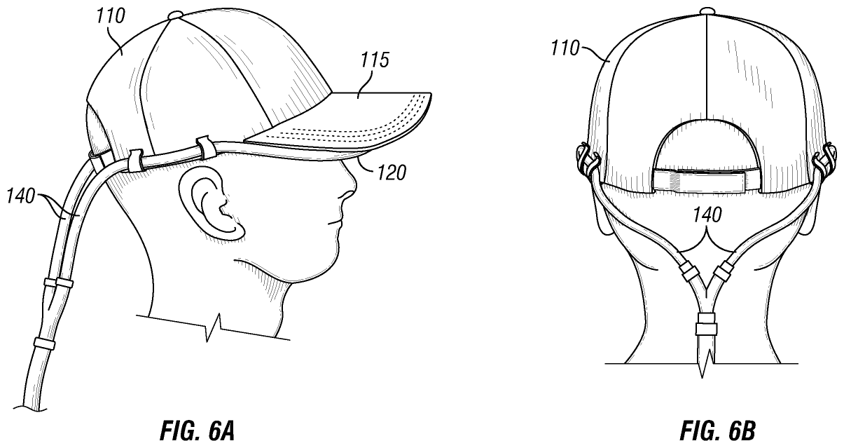

Referring now to FIGS. 5A and 5B, attachable fluid manifold system 500 is shown, and includes flowable fluid manifold 120, supply tube 140, and air pump 380. Flowable fluid manifold 120 includes flowable fluid distribution ports 125, configured so that the fluid flow is in direction of fluid flow 130 in a substantially vertical plane when flowable fluid manifold 120 is in a substantially horizontal position. Alternatively, in other embodiments, one or more flowable fluid manifolds could extend downwardly from the sides of a brim to provide a protective air curtain in front of a user's facial features in a horizontal plane. Fluid manifold attachment clips 522 are affixed to flowable fluid manifold 120 so that the entire system can be removably and adjustably attached to any type of head covering with a brim, or to glasses or other headbands, visors, or head-mounts. Fluid manifold attachment clips 522 can include clips, ties, magnets, adhesives, or any other type of device capable of attaching flowable fluid manifold 120 to a head covering or apparel worn on the head. Flowable fluid manifold 120 is connected to supply tube 140, which is connected to air pump 380. Air pump 380 includes air intake 270 and filter 275.

Referring now to FIGS. 6A-6E, depictions of head-mount portion of the protective air curtain device 100 are shown from different views. Head-mount 110 with frontal brim 115 is provided on a mannequin representing a user. As shown in FIG. 6B, two supply tubes 140 traverse the sides of head-mount 110 to provide flowable fluid from fluid supply (not shown) to flowable fluid manifold 120. Flowable fluid manifold 120 is attached to frontal brim 115 and includes flowable fluid distribution ports 125 configured such that when flowable fluid such as air is provided, the facial protective air curtain is generated in front of the user's facial features. Flowable fluid manifold 120 is attached to bottom of frontal brim 115 proximate the forehead of the mannequin. In some embodiments, flowable fluid manifold 120 is positioned between about 1 inch and 5 inches, or between about 3 inches and about 4 inches, or about 3 inches forwardly in front of a user's forehead. Flowable fluid manifold 120 can be rotatably tilted toward or away from a user's face and affixable in a set position.

In the embodiment of FIG. 6B, supply tubes 140 are shown splitting at a Y joint to provide an air supply to both sides of flowable fluid manifold 120. The plastic tubing air distribution of supply tubes 140 (a pig-tail “Y”) is intended to smoothly split the singular air flow from a pump to the manifold dispersion device (a brass tube in the embodiment shown). This surprisingly and unexpectedly significantly reduces pressure and flow reductions exiting the holes in the manifold. In the embodiment of FIG. 6B, the total weight of supply tubes 140 and flowable fluid manifold 120 is less than about 1 oz. In addition to or alternative to brass, other lightweight materials and metals such as aluminum, carbon steel, polymers, carbon fiber, or any combination thereof can be used in manifolds or supply tubes of the present disclosure. In some embodiments, 3D printing can be applied to materials of the head-mount, supply tubes, and/or filtration pack, for example to make components out of lightweight materials such as plastics once designed in a compact fashion.

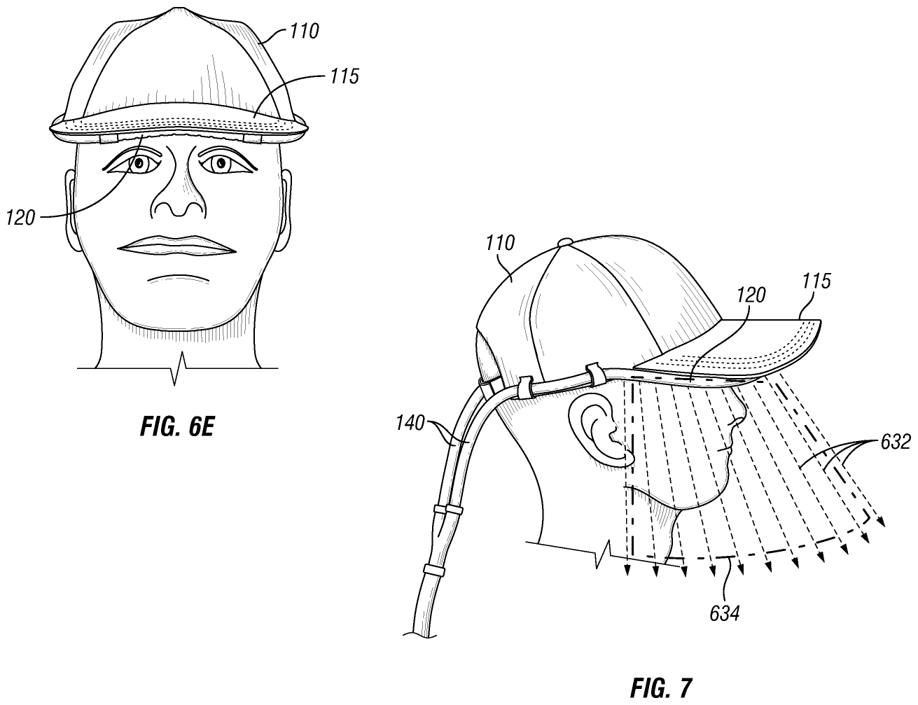

Referring now to FIG. 7, a side profile of a user with the head-mount and manifold portion of the medical device is shown. Head-mount 110 is placed on a user's head. Flowable fluid manifold 120 is attached to the underside of frontal brim 115. Forward angled air curtain 632 is shown extended from flowable fluid manifold 120 downward and forward of the user's face. The position of forward angled air curtain 632, extending temple-to-temple in a substantially U-shaped cross-section from brim to chin, jawline, and/or neck, generates air pocket 634 of a substantially wedge-like vertical cross-section (from the side profile) and a substantially U-shaped horizontal cross section (from the top), surrounding the user's facial features extending cross-wise from proximate a first temple, proceeding in front of the user's face, to proximate a second temple. The position of forward angled air curtain 632 generates air pocket 634 of increasing volume from the user's forehead to chin, where forward angled air curtain 632 is positioned closer to the user's forehead and further away from the user's chin. Air pocket 634 is deeper at the user's mouth than at the user's forehead. Advantageously, and surprisingly and unexpectedly, air pocket 634 being of greater depth at the user's nose and mouth generates an additional margin of safety for the user from the outside environment. Air pocket 634 is a zone of ambient air segregated from the outside environment by forward angled air curtain 632. Air pocket 634 provides breathing air that does not come from forward angled air curtain 632 or outside of forward angled air curtain 632.

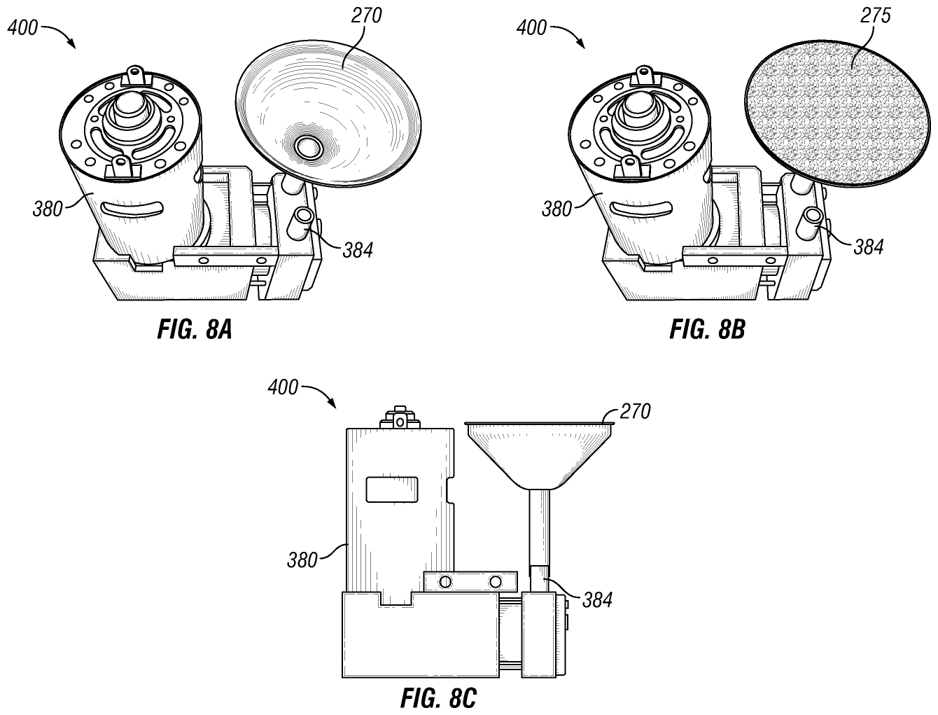

Referring now to FIGS. 8A-8C, drawings of an embodiment of fluid supply 400 are shown from different views. In FIGS. 8A and 8C, air pump 380 is shown having air intake 270 with no filter. FIG. 8B shows air pump 380 with filter 275 removably attached to air intake 270. Air outlet 384 is shown without supply tubes connected. In some embodiments, the speed and power of an air compressor, air blower, and/or air pump is adjustable, for example via the power provided by a lithium ion battery, to adjust the strength of a facially-protecting air curtain. For example, by increasing battery power to an air pump, air flow from a flowable fluid manifold can be increased to increase the length, width, and depth of a facial air curtain via increased air flow from the flowable fluid manifold to protect a user's face in risky environments, such as with multiple other persons or when there is environmental wind.

### EXAMPLES

In an experiment, vivid, contrasting (red) spray paint was sprayed from a distance of about 4-8 feet away towards the facial features of a mannequin, similar to that of FIG. 6, to simulate a sneeze or a projection of particulates, bacteria, and/or viruses aimed at a user's face. Without any protection, the particles of vivid, contrasting spray paint reached and landed on the facial features of the mannequin, including the eyes, nose, and mouth.

In the experiment, the device generating the protective facial air curtain, similar to that of FIGS. 6 and 7, was placed on the mannequin and activated. Once again, vivid, contrasting spray paint was sprayed, under identical conditions, from a distance of 4-8 feet away towards the facial features of the mannequin to simulate a sneeze or a projection of particulates, bacteria, and/or viruses aimed at a user's face. The vivid, contrasting spray paint particulates did not pass through the protective facial air curtain to reach the mannequin's facial features. The protective facial air curtain thus protected the user from the particulates and aerosols. The air curtain's effectiveness in prohibiting aerosols and particulates in this experiment has been repeated using fluorescent sprayed particles and black UV light for detection.

Prevention of flow of contaminated air to the human face while using the device can approach 80% to 95%. Effectiveness of the air curtain can be maintained when temperature, humidity, air density, and pressure are approximately the same on an internal side of the air curtain proximate a user's facial features and an external side of the air curtain away from a user's facial features. For varying environmental conditions such as a wind or breeze, temperature fluctuations, heating, and air conditioning, the flowable fluid supply rate to a fluid manifold can be adjustable by a user to provide additional fluid flow to the facial air curtain to maintain its effectiveness in light of environmental changes.

In one tested embodiment, 40 liters per minute of air was pumped through plastic tubing having a 0.25″ internal diameter. 15 drilled orifices, each at 0.0625″ diameter, were used on a flowable fluid distribution manifold (brass tube) to create a protective facial air curtain. Of course, in other embodiments, a wide range of and optional combinations of holes, slots, and other orifice shapes and sizes are available. Holes in a flowable fluid manifold can range from about 0.005″ to about 0.25″, or in some other embodiments, one or more thin, narrow slot is provided along the length of a flowable fluid manifold to form the air curtain. For example, narrow milled slots, instead of holes or in addition to holes, can be analyzed by fluid mechanics programs known to those of ordinary skill in the art to test differences in air curtain morphology and to optimize air curtain morphology for pathogen protection and extended life of a given device. Such holes or slots can be angled forwardly on an air manifold upon manufacture, and in some embodiments the air manifold exhibits adjustable ports to be angled forwardly, for example in accordance with the embodiment of FIG. 7. Injection molding, 3D printing, or any other known manufacturing method for lightweight parts can be used to manufacture embodiments of the present disclosure.

The singular forms “a,” “an,” and “the” include plural referents, unless the context clearly dictates otherwise. The term “about” includes values and ranges within plus or minus 5% of a given value or range.

In the drawings and specification, there have been disclosed embodiments of systems and methods for generating a protective facial air curtain of the present disclosure, and although specific terms are employed, the terms are used in a descriptive sense only and not for purposes of limitation. The embodiments of the present disclosure have been described in considerable detail with specific reference to these illustrated embodiments. It will be apparent, however, that various modifications and changes can be made within the spirit and scope of the disclosure as described in the foregoing specification, and such modifications and changes are to be considered equivalents and part of this disclosure.

What is claimed is:

1. A medical device for providing a protective air curtain around a user's facial features, the device comprising:
a head-mount wearable by the user, the head-mount comprising a frontal brim;
a light, wearable filtration pack, the filtration pack comprising a flowable fluid supply;
a flowable fluid manifold affixable to the frontal brim, the flowable fluid manifold comprising a plurality of flowable fluid distribution ports along the brim and operable to generate the protective air curtain angled downwardly and forwardly away from a plane extending perpendicular to the frontal brim when a flowable fluid is provided to the flowable fluid manifold and away from the user's facial features generating a protective air pocket extending from a first temple of the user to a second temple of the user, whereby total fluid flow to the flowable fluid manifold and through the plurality of flowable fluid distribution ports across the flowable fluid manifold is between about 30 liters per minute and 50 liters per minute to block airborne viruses, bacteria, and aerosols, and whereby the user does not feel the protective air curtain on the user's facial features; and
a supply tube comprising a first end and a second end, the first end fluidly connected to the flowable fluid manifold, and the second end fluidly connected to the flowable fluid supply, such that the flowable fluid is supplied from the flowable fluid supply to the flowable fluid manifold,
whereby the protective air curtain is generated about 2.5 inches from a user's forehead, whereby the protective air pocket has a minimum depth of 2.5 inches and increases in depth as the protective air curtain descends downward and forwardly away from the user's facial features, and whereby the protective air pocket has a substantially U-shaped horizontal cross-section extending from the frontal brim to a user's chin and a substantially wedge-like vertical cross-section, wherein the U-shaped horizontal cross-section and the wedge-like vertical cross section are adjustable via the flowable fluid manifold being rotatably tilted towards or away from the user's facial features between about 5 degrees and about 45 degrees forward from the perpendicular plane extending downwardly from the frontal brim of the head mount, the protective air curtain forming an environmental divide between the protective air pocket and an environment external to the air pocket.

2. The medical device according to claim 1, wherein the flowable fluid supply is operable to produce filtered air.

3. The medical device according to claim 1, wherein the head-mount wearable by the user is selected from the group consisting of: a hat, a visor, and a cap.

4. The medical device according to claim 1, wherein the light, wearable filtration pack comprises an air intake, an air pump, and a filter, the air pump operable to produce filtered air by drawing ambient air through the air intake and the filter.

5. The medical device according to claim 4, wherein the light, wearable filtration pack further comprises a battery to operate at least one of the air intake or the air pump.

6. The medical device according to claim 5, wherein the battery comprises a rechargeable lithium ion battery.

7. The medical device according to claim 4, wherein the filter comprises a removable and replaceable N-95 filter.

8. (canceled)

9. The medical device according to claim 1, wherein the light, wearable filtration pack comprises a supplemental oxygen or compressed air supply as at least a portion of the flowable fluid supply to the protective air curtain.

10. The medical device according to claim 1, whereby the protective air curtain does not intersect and does not flow into the user's facial features such that the user does not feel the protective air curtain on the user's facial features, the facial features selected from the group consisting of: a user's forehead, a user's eyes, a user's nose, a user's mouth, the user's chin, and combinations of the same.

11. The medical device according to claim 1, wherein the plurality of flowable fluid distribution ports is positioned whereby the protective air curtain surrounds the user's face vertically downward from the frontal brim to proximate a user's neck.

12. The medical device according to claim 1, wherein the protective air curtain is positioned whereby the protective air pocket is increasing in depth sequentially from the user's forehead, to a user's eyes, to a user's nostrils, to a user's mouth, and is operable to provide sequentially increasing protection to the user's eyes, the user's nostrils, and the user's mouth.

13. (canceled)

14. The medical device according to claim 13, whereby the protective air pocket between the user's eyes and the protective air curtain is between about 2.5 inches and about 5 inches deep, the protective air pocket between the user's nostrils and the protective air curtain is between about 2.5 inches and about 6 inches deep, and the protective air pocket between the user's mouth and the protective air curtain is between about 2.5 inches and about 7 inches deep.

15. A system for adding a protective air curtain to a head-mount, the system comprising:
a light, wearable filtration pack comprising a flowable fluid supply;
a supply tube, fluidly connected to the flowable fluid supply, the supply tube operable to transport a fluid; and
a flowable fluid manifold comprising a plurality of flowable fluid distribution ports, the flowable fluid manifold fluidly connected to the supply tube, the flowable fluid manifold operable to generate a pressurized screen of the fluid when the fluid is provided to the flowable fluid manifold through the supply tube, wherein the pressurized screen of the fluid is generated downwardly and forwardly away from facial features of a user when the flowable fluid manifold is connected to the head-mount, generating a protective air pocket extending from a first temple of the user to a second temple of the user and away from a plane extending perpendicular to a frontal brim of the head-mount, the protective air pocket having a substantially U-shaped horizontal cross-section extending from the head-mount to a user's chin and a substantially wedge-like vertical cross-section, wherein the U-shaped horizontal cross-section and the wedge-like vertical cross section are adjustable via the flowable fluid manifold being rotatably tilted towards or away from the facial features of the user between about 5 degrees and about 45 degrees forward from the perpendicular plane extending downwardly from the frontal brim of the head mount, and whereby total fluid flow to the flowable fluid manifold and through the plurality of flowable fluid distribution ports across the flowable fluid manifold is between about 30 liters per minute and 50 liters per minute to block airborne viruses, bacteria, and aerosols, and whereby the user does not feel the protective air curtain on the user's facial features.

16. The system of claim 15, further comprising an attachment device, the attachment device operable to removably affix the flowable fluid manifold to the head-mount wearable by a user.

17. The system of claim 15, wherein the filtration pack further comprises an air compressor, an air intake, and an air outlet, the air compressor operable to produce a differential pressure to move air from the air intake to the air outlet, the air outlet fluidly connected to the supply tube.

18. The system of claim 17, further comprising a filter, the filter enclosing the air intake, the filter operable to remove pollutants, pathogens, particulates, and microorganisms to generate filtered air.

19. The system of claim 15, further comprising a compressed air supply.

20. (canceled)

21. The system of claim 15, whereby the protective air pocket is of increasing depth between a user's forehead and a user's mouth.

22. The system of claim 21, whereby the flowable fluid manifold is positioned between about 2.5 inches and about 5 inches from a user's forehead, whereby the protective air pocket between the user's eyes and the pressurized screen of the fluid is between about 2.5 inches and about 4 inches deep, the protective air pocket between the user's nostrils and the pressurized screen of the fluid is between about 2.5 inches and about 6 inches deep, and the protective air pocket between the user's mouth and the pressurized screen of the fluid is between about 2.5 inches and about 7 inches deep.

23. The system of claim 15, whereby the user does not feel the pressurized screen of the fluid on the user's facial features due to a forward angle of the pressurized screen.

24. A method of blocking pathogens from nearing an individual's facial features, the method comprising the steps of:
generating a differential pressure, the differential pressure operable to move air from an environment surrounding the individual through a filter;
filtering the air through the filter, the filter able to remove pollutants, pathogens, and microorganisms to generate filtered air;
forcing the filtered air through a plurality of fluid distribution ports in a flowable fluid manifold to generate a protective air curtain, whereby the protective air curtain is generated about 2.5 inches from the individual's forehead, and whereby the protective air curtain generates a protective air pocket extending from a first temple of the user to a second temple of the user having a minimum depth of 2.5 inches, whereby the protective air pocket increases in depth as the protective air curtain descends downward and forwardly away from the user's facial features, whereby the protective air pocket has a substantially U-shaped horizontal cross-section extending from the individual's forehead to an individual's chin and a substantially wedge-like vertical cross-section, wherein the U-shaped horizontal cross-section and the wedge-like vertical cross section are adjustable via the flowable fluid manifold being rotatably tilted towards or away from the individual's facial features between about 5 degrees and about 45 degrees forward from a perpendicular plane extending downwardly from a frontal brim, whereby total fluid flow to the plurality of fluid distribution ports across the flowable fluid manifold is between about 30 liters per minute and 50 liters per minute to block airborne viruses, bacteria, and aerosols, and whereby the user does not feel the protective air curtain on the user's facial features; and
directing the protective air curtain to surround the individual's facial features, such that the protective air curtain prevents pathogens from passing through the protective air curtain and nearing the individual's facial features.

25. The method of claim 24, further comprising the step of pushing the filtered air through a supply tube, the supply tube fluidly connecting the flowable fluid manifold and the filter, such that the filtered air is transported from the filter to the flowable fluid manifold.

26. (canceled)

27. (canceled)

28. (canceled)

29. The method of claim 24, wherein the air pocket is sufficiently deep and robust, based on air flow, to prevent an inhalation or exhalation of the individual from interrupting the protective air curtain.

30. The method of claim 24, whereby the protective air pocket between the user's eyes and the protective air curtain is between about 2.5 inches and about 5 inches deep, the protective air pocket between the user's nostrils and the protective air curtain is between about 2.5 inches and about 6 inches deep, and the protective air pocket between the user's mouth and the protective air curtain is between about 2.5 inches and about 7 inches deep.
